(19) United States
(12) Patent Application Publication
(10) Pub. No.: US 2024/0015717 A1
(43) Pub. Date: Jan. 11, 2024

(54) ENABLEMENT RELATION RULE FOR BEAM INDICATION SCHEMES

(71) Applicant: QUALCOMM Incorporated, San Diego, CA (US)

(72) Inventors: Yan ZHOU, San Diego, CA (US); Fang YUAN, Beijing (CN); Tao LUO, San Diego, CA (US)

(21) Appl. No.: 18/020,413

(22) PCT Filed: Sep. 9, 2020
(86) PCT No.: PCT/CN2020/114246

§ 371 Date: Feb. 8, 2023

(51) Int. Cl. H04W 72/044; H04B 7/06

(52) U.S. Cl. CPC H04W 72/046; H04B 7/0695

(57) ABSTRACT

A configuration to apply an indication scheme based on an enablement rule for various beam indication schemes. The apparatus determines that a first beam indication scheme is enabled. The apparatus determines that a second beam indication scheme is not enabled based on the first beam indication scheme being enabled. The apparatus applies the first beam indication scheme to determine one or more of an UL beam or a DL beam for communication with a base station.

### BACKGROUND

### Technical Field

The present disclosure relates generally to communication systems, and more particularly, to an enablement relation rule for beam indication schemes.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a UE. The device may be a processor and/or a modem at a UE or the UE itself. The apparatus determines that a first beam indication scheme is enabled. The apparatus determines that a second beam indication scheme is not enabled based on the first beam indication scheme being enabled. The apparatus applies the first beam indication scheme to determine one or more of an uplink (UL) beam or a downlink (DL) beam for communication with a base station.

In an aspect of the disclosure, a method, a computer-readable medium, and an apparatus are provided. The apparatus may be a device at a base station. The device may be a processor and/or a modem at a base station or the base station itself. The apparatus indicates to a user equipment (UE), that a first beam indication scheme is enabled, wherein enablement of the first beam indication scheme further indicates that a second beam indication scheme is not enabled. The apparatus applies the first beam indication scheme to activate one or more of an uplink (UL) beam or a downlink (DL) beam for communication with the UE.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating a MAC-CE for activating joint DL/UL TCI states.

FIG. 5 is a call flow diagram of signaling between a UE and a base station.

FIG. 6 is a flowchart of a method of wireless communication.

FIG. 7 is a diagram illustrating an example of a hardware implementation for an example apparatus.

FIG. 8 is a flowchart of a method of wireless communication.

FIG. 9 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

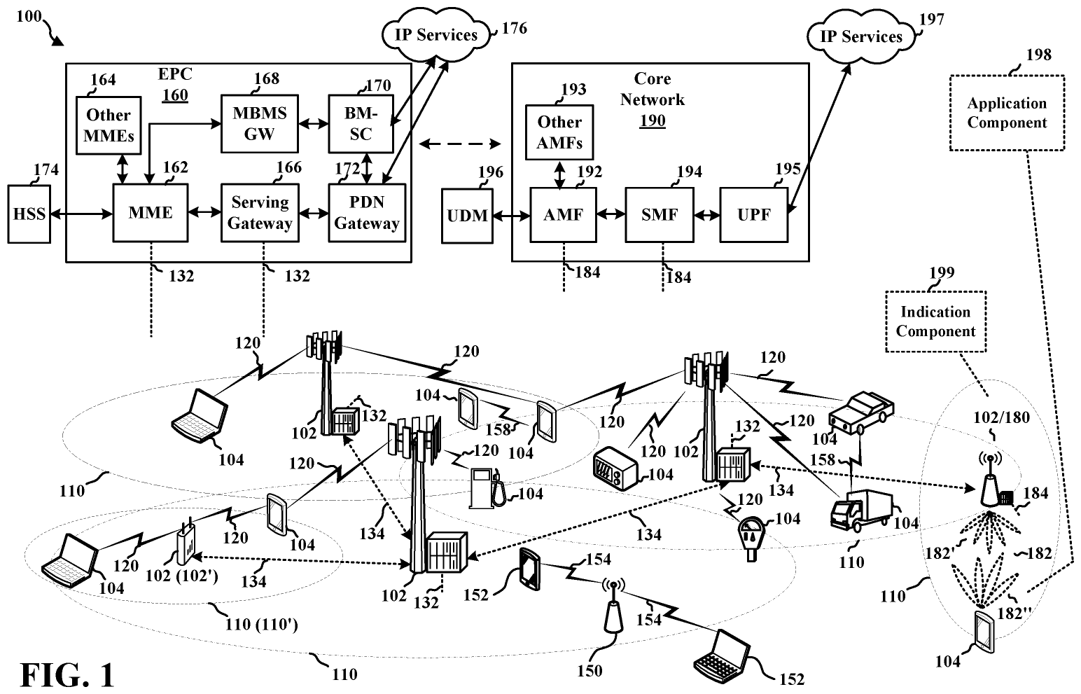

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may be configured to apply an indication scheme based on an enablement rule for various beam indication schemes. For example, the UE 104 may comprise an application component 198 configured to apply an indication scheme based on an enablement rule for various beam indication schemes. The UE 104 may determine that a first beam indication scheme is enabled. The UE 104 may determine that a second beam indication scheme is not enabled based on the first beam indication scheme being enabled. The UE 104 may apply the first beam indication scheme to determine one or more of an uplink (UL) beam or a downlink (DL) beam for communication with a base station.

Referring again to FIG. 1, in certain aspects, the base station 180 may be configured to provide an indication of an enablement of beam indication scheme based on an enablement rule for various beam indication schemes. For example, the base station 180 may comprise an indication component 199 configured to provide an indication of an enablement of beam indication scheme based on an enablement rule for various beam indication schemes. The base station 180 may indicate to a user equipment (UE), that a first beam indication scheme is enabled, wherein enablement of the first beam indication scheme further indicates that a second beam indication scheme is not enabled. The base station 180 may apply the first beam indication scheme to activate one or more of an uplink (UL) beam or a downlink (DL) beam for communication with the UE.

Although the following description may be focused on 5G NR, the concepts described herein may be applicable to other similar areas, such as LTE, LTE-A, CDMA, GSM, and other wireless technologies.

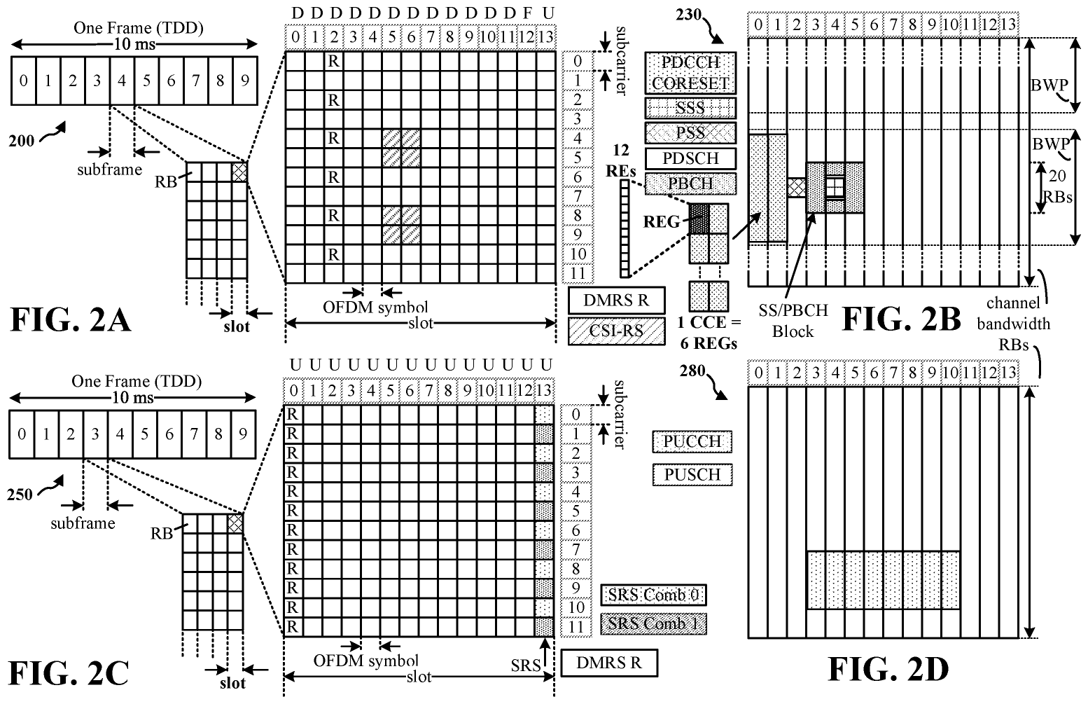

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame.

The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) ACK/NACK feedback. The PUSCH carries data, and may additionally be used to carry a buffer status report (BSR), a power headroom report (PHR), and/or UCI.

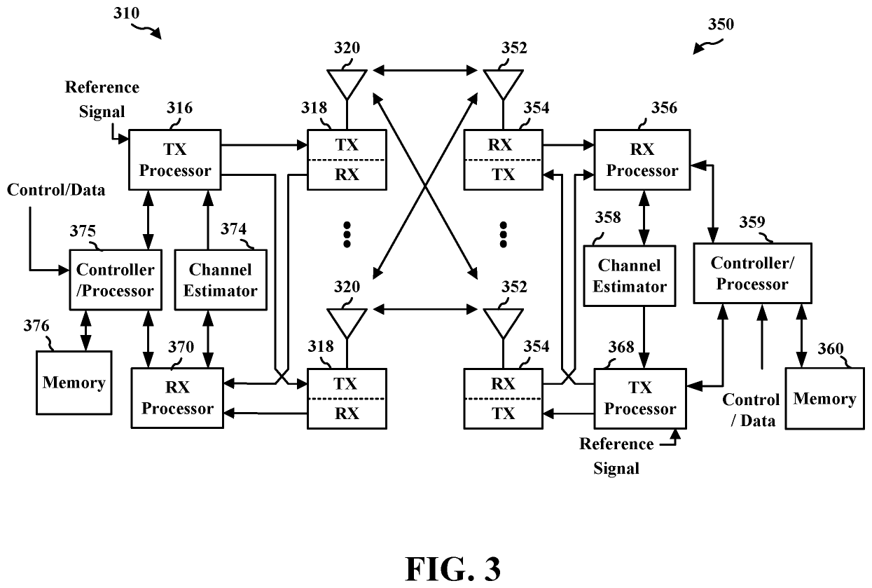

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate an RF carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIB s) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 198 of FIG. 1.

In wireless communications, signaling a common beam for multiple DL and UL resources may be utilized to save both beam indication overhead and latency. The common beam indication may be signaled via a joint DL/UL TCI state. However, further clarification should indicate whether the joint DL/UL TCI state may be enabled simultaneously with other beam indication schemes, e.g., DL/UL only TCI state.

Aspects presented herein provide an enhancement on multi-beam operation, such as but not limited to, targeting frequency range 2 (FR2) while also being applicable to frequency range 1 (FR1). Aspects presented herein may facilitate more efficient, e.g., lower latency and overhead, DL/UL beam management to support higher intra and Layer-1/Layer-2 centric inter-cell mobility and/or a larger number of configured TCI states. For example, aspects may enable the configuration and/or activation of a common beam for data and control transmission/reception for DL and UL, especially for intra-band carrier aggregation (CA), a unified TCI framework for DL and UL beam indication, or enhancement on signaling mechanisms to improve latency and efficiency with more usage of dynamic control signaling, e.g., as compared to RRC signaling. Aspects may further facilitate UL beam selection for UEs equipped with multiple panels, considering UL coverage loss mitigation due to maximum permissible exposure (MPE), based on UL beam indication with the unified TCI framework for UL fast panel selection.

Aspects presented herein provide a configuration to allow a UE to utilize an enablement relation rule for beam indication schemes. The enablement relation rule may indicate that a first beam indication scheme is enabled, whereby a second beam indication scheme may or may not be enabled simultaneously.

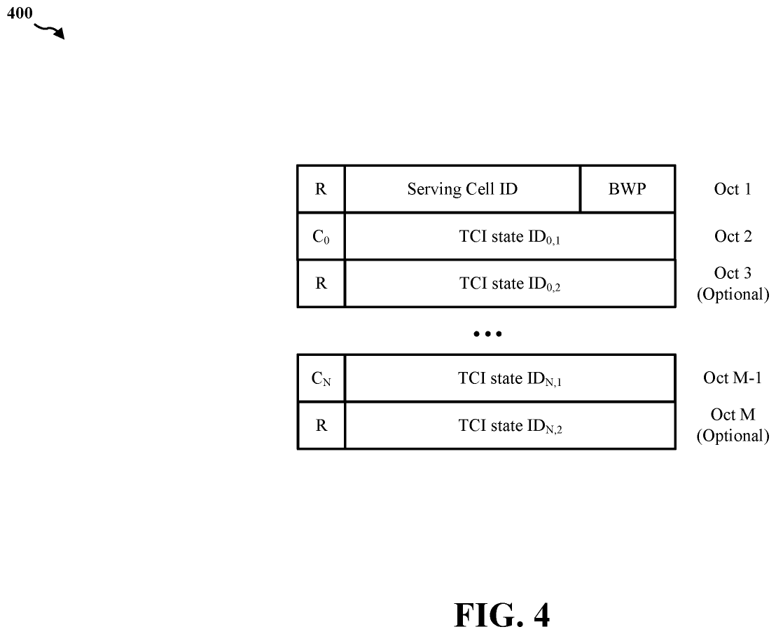

FIG. 4 is an example 400 illustrating a MAC-CE 412 for activating joint DL/UL TCI states and DL/UL communication. The MAC-CE 412 may be a UE-specific MAC-CE for TCI state activation/deactivation, which is transmitted on PDSCH from a base station to a UE. The TCI state activation/deactivation for UE-specific MAC-CE is identified by a MAC PDU subheader. The MAC-CE 412 may have a variable size bitmap including a serving cell ID field, a BWP ID field, a Cᵢ field, TCI state ID_{i,j} field, and a reserved (R) field. The serving cell ID may indicate the identity of the serving cell for which the MAC-CE 412 applies in the case of carrier aggregation (CA). The MAC-CE 412 may activate the TCI states for any of data channel such as PDSCH, PUSCH, or control channel such as control resource set (CORESET), PUCCH, or RS signal such as CSI-RS and SRS for UE 402. The length of the field may be 5 bits, for example. The BWP ID indicates a DL BWP for which the MAC-CE 412 applies as the codepoint. The length of the BWP ID field may be 2 bits, for example. The Cᵢ field indicates whether the octet containing TCI state ID_{i,2} is present for the ith TCI codepoint (i=0, . . . N). If this field is set to “1”, the octet containing TCI state ID_{i,2} is present. If this field is set to “0”, the octet containing TCI state ID_{i,2} is not present. The TCI state ID_{i,j} field indicates the TCI state, where i is the index of the codepoint and TCI state ID_{i,j} denotes the j^{th} TCI state indicated for the i^{th} codepoint. The TCI codepoint to which the TCI states are mapped is determined by its ordinal position among all the TCI codepoints with sets of TCI state ID_{i,j} fields, i.e., the first TCI codepoint with TCI state ID_{0,1} and TCI state ID_{0,2} is mapped to the codepoint value 0, the second TCI codepoint with TCI state ID_{1,1} and TCI state ID_{1,2} is mapped to the codepoint value 1, and so on. The TCI state ID_{i,2} is optional based on the indication of the Cᵢ field. The maximum number of activated TCI codepoints may be 8 (accordingly, N≤7) and the maximum number of TCI states mapped to a TCI codepoint may be 2. In one configuration, the maximum number of TCI states mapped to a TCI codepoint may greater than 2. When the number of TCI states mapped to a TCI codepoint is M>2 (TCI state ID_{i,m}, m=1, . . . , M), there may be a number of M−1 Cᵢ field for a TCI codepoint, respectively indicating that whether each of the TCI state ID_{i,m} is present or not, where m=2, . . . , M. The R field is a reserved bit that may be set to “0”.

In case of single-DCI based multi-TRP, one TRP can schedule DL receptions or UL transmissions simultaneously with each of multiple TRPs by sending a single scheduling DCI. In this case, the corresponding activation MAC-CE may activate at least one set of at least one joint DL/UL TCI state. At least in case of a single activated set, each of the multiple activated joint DL/UL TCI states may be sequentially applied to DL receptions or UL transmissions associated with each of the multiple scheduled TRPs. For example, if a MAC-CE activates only the 0th set with two joint DL/UL TCI states, the two joint TCI states are 1-to-1 mapped to two TRPs scheduled by all scheduling DCIs, where the channel types or resources of DL receptions or UL transmissions per scheduled TRP is dynamically indicated in each scheduling DCI. The channel types or resources for DL receptions associated with a TRP can be such as PDSCH, PDCCH or COREST, CSI-RS, and the channel types or resources for UL transmission associated with a TRP can be such as PUSCH, PUCCH, SRS, or PRACH. Therefore, each scheduling DCI may not have a field of TCI codepoint and may not need to specify the used joint TCI state for channel types or resources of DL receptions or UL transmissions per scheduled TRP. Resources for DL receptions or UL transmissions with multiple scheduled TRPs may be frequency division multiplexed (FDMed), time division multiplexed (TDMed), or spatially division multiplexed (SDMed), which may be dynamically indicated in each scheduling DCI. For example, a 1^{st} scheduling DCI schedules two FDMed PDSCHs with two TDMed PUCCHs associated with two TRPs, and a 2^{nd} scheduling DCI schedules two TDMed PUSCHs associated with two TRPs. For both scheduling DCIs, the two joint TCI states in the 0^{th} set activated by the MAC-CE may be applied to resources allocated for DL receptions or UL transmissions associated with the two TRPs, respectively. For example, 1^{st} joint TCI states may be applied to 1^{st} PDSCH in two FDMed PDSCHs, 1^{st} PUCCH in two TDMed PUCCHs, and 1^{st} PUSCH in two TDMed PUSCHs, and similarly, 2^{nd} joint TCI states may be applied to 2^{nd} PDSCH in two FDMed PDSCHs, 2^{nd} PUCCH in two TDMed PUCCHs, and 2^{nd} PUSCH in two TDMed PUSCHs. The mapping between joint TCI state and resources of DL receptions or UL transmissions associated with each TRP may be determined in the specification (i.e., predetermined) or dynamically by the base station via RRC/MAC-CE/DCI.

If multiple sets of joint TCI state(s) are activated by the MAC-CE, e.g., N+1 sets and N>0, a DCI may further indicate a TCI codepoint which is mapped to one of the multiple sets of joint TCI state(s). In a first configuration, the indicated TCI codepoint may be used only for resources of DL receptions or UL transmissions scheduled by the same DCI indicating the TCI codepoint. For example, 1^{st}/2^{nd} joint TCI states may be applied to 1^{st}/2^{nd} PDSCH and 1^{st}/2^{nd} PUCCH scheduled by this DCI, respectively. In a second configuration, the indicated TCI codepoint may be used for DL receptions or UL transmissions scheduled by all the following scheduling DCIs. For example, a first DCI may indicate one TCI codepoint which is mapped to a set of 1^{st} and 2^{nd} joint TCI states, and 1^{st}/2^{nd} joint TCI states may be applied to resources of DL receptions or UL transmissions for 1 s t/2^{nd} TRPs scheduled by all the scheduling DCIs following the first DCI. Within the multiple TCI codepoints corresponding to multiple activated sets of joint DL/UL TCI states, one TCI codepoint may be defined to indicate a set of default common beams, e.g., the TCI codepoint with lowest/highest codepoint ID, at least when no TCI codepoint is indicated by any DCI.

The base station and the UE may apply different beam indication schemes for the UE to determine beam(s) for communication with the base station. An example of a beam indication scheme (e.g., Scheme 1) includes a scheme in which a joint DL/UL TCI state may be indicated by the base station to the UE for determining a downlink beam and an uplink beam for communication with the base station. The joint DL/UL TCI state may indicate a common beam for DL and UL communication. The channels to apply the indication of joint DL/UL TCI state may include any of PDCCH, PDSCH, PUCCH, PUSCH, PRACH, CSI-RS or SRS.

In some aspects, the joint DL/UL TCI state may be for single TRP in some examples. In other examples, the joint DL/UL TCI state may be for multiple TRPs with multiple DCI (mDCI), where different DCIs may be used to schedule transmission or receptions associated with different TRPs. In other examples, the joint DL/UL TCI state may be for multiple TRPs based on a single DCI (sDCI), where a single DCI may be used to schedule transmission or receptions associated with different TRPs.

Another example of a beam indication scheme (e.g., Scheme 2) is a DL only TCI state scheme that indicates a TCI state or beam for downlink communication, but not for uplink communication, e.g., DL only TCI state indication. The channels to apply the indication of DL only TCI state may include any of PDCCH, PDSCH, or CSI-RS.

Another example of a beam indication scheme (e.g., Scheme 3) is an UL only TCI state scheme that indicates a TCI state or beam for uplink communication, but not for downlink communication, e.g., UL only TCI state indication. The channels to apply the indication of UL only TCI state may include any of PUCCH, PUSCH, PRACH or SRS.

Another example of a beam indication scheme (e.g., Scheme 4) is a spatial relation information scheme that provides spatial relation information for a UE to determine a beam for uplink communication, e.g., spatial relationship information indication for PUCCH, PRACH or SRS.

Another beam indication scheme (e.g., Scheme 5) may indicate a default beam for one or more channels or signals. The default beam is applied for one or more channels or signals when these channels or signals are scheduled but not explicitly configured or indicated with any beam information. For example, a beam indication scheme (e.g., Scheme 5) may provide a default beam for one or more of PUCCH, SRS, and/or PUSCH, e.g., default beam scheme for PUCCH, SRS, or PUSCH. The beam indication scheme may comprise two scenarios to apply the default beam or default spatial relationship for PUCCH, SRS, or PUSCH:
1. Scenario 1: Dedicated PUCCH or SRS for a serving cell in FR2 without any configured spatial relation.
2. Scenario 2: PUSCH scheduled by DCI format 0_0 when no PUCCH is configured or none of PUCCH has configured spatial relation on the active UL BWP in FR2.

For each scenario above, since no spatial relation information is explicitly indicated, the default spatial relation information for PUCCH, SRS or PUSCH are determined following two cases:
1. When CORESET(s) are configured on the serving cell, the RS providing quasi-co-location (QCL)-TypeD assumption in the TCI state/QCL assumption of the CORESET with the lowest ID in active BWP serves as the default spatial relation.
2. When any CORESET is not configured on the serving cell, the RS providing QCL-TypeD assumption in the activated PDSCH TCI state with the lowest TCI codepoint ID in active DL BWP serves as the default spatial relation.

Another beam indication scheme (e.g., Scheme 6) may indicate one or more default PDSCH beams. The default PDSCH beams may be for a single TRP, mDCI based TRs, or sDCI based TRPs. For example, the default PDSCH beams may include the default PDSCH beam(s) for single TRP, where default PDSCH beam is applied,
1. if the RRC parameter “tci-PresentInDCI” is not configured for the CORESET scheduling the PDSCH or the PDSCH is scheduled by a DCI format 1_0, and the time offset between the reception of the DL DCI and the corresponding PDSCH is equal to or greater than a threshold timeDurationForQCL.
2. if the offset between the reception of the DL DCI and the corresponding PDSCH is less than the threshold timeDurationForQCL.

In addition, the default PDSCH beams may include the default PDSCH beam(s) for m-DCI or sDCI based multiple TRP.

Aspects presented herein provide a relation rule that a UE and/or base station may apply to determine one or more beam indication schemes among a group of beam indication schemes that are enabled for communication between the UE and the base station. For example, if one beam indication scheme is enabled, another beam indication scheme may be enabled simultaneously or may not be enabled simultaneously, e.g., based on the relation rule between the beam indication schemes. In some examples, the beam indication scheme may be enabled via an explicit flag, e.g., RRC flag that the base station transmits to the UE. For example, there may be an RRC flag for each of Scheme 1-6, and if the RRC flag is set as “enabled”, the corresponding beam indication is enabled, otherwise disabled. In another example, the enablement of a beam indication scheme may be implied through other signaling, such as by a configuration of corresponding beam indicator(s) related to the beam indication schemes. For example, if a TCI state list for joint DL/UL TCI states is configured by RRC signaling, Scheme 1 may be enabled, otherwise disabled. In another example, the enablement of a beam indication scheme may be implied by the base station's activation of a particular configured beam indicator(s) for the UE related to the beam indication schemes. For example, if a MAC-CE activates a set of TCI states and all the activated TCI states in the set are corresponding to the joint DL/UL TCI states, scheme 1 may be enabled. The beam indication schemes covered by the enablement relation rule may include any of
1. Scheme 1: joint DL/UL TCI state for single TRP, mDCI based TRP, or sDCI based TRP;
2. Scheme 2: DL only TCI state;
3. Scheme 3: UL only TCI state;
4. Scheme 4: Spatial relation information for uplink;
5. Scheme 5: Default beam or spatial relation information for PUCCH, SRS, or PUSCH;
6. Scheme 6: Default PDSCH beam(s) for single TRP, mDCI based TRP, sDCI based TRP.

The enablement relation rule may be based on a conflict between one or more beam indication schemes. For example, if the joint DL/UL TCI state for single TRP is enabled (e.g., Scheme 1), DL/UL transmission or reception may follow the activated joint DL/UL TCI state, and hence, the DL TCI state (e.g., DL only) TCI state, UL TCI state (e.g., UL only TCI state), or spatial relation information based beam indication schemes (e.g., Scheme 2,3,4) may not be enabled simultaneously with the joint DL/UL TCI state beam indication scheme.

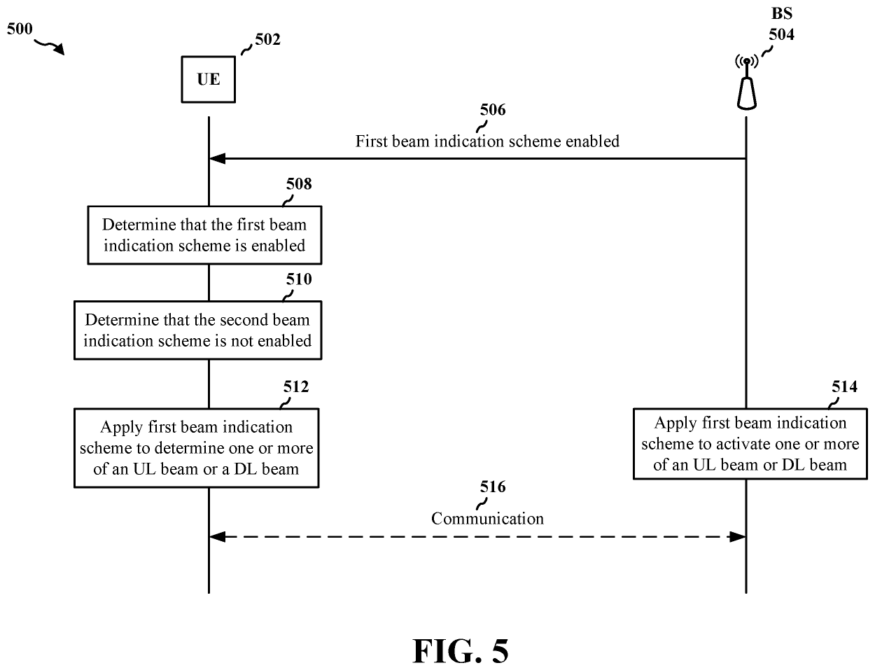

FIG. 5 is a call flow diagram 500 of signaling between a UE 502 and a base station 504. The base station 504 may be configured to provide at least one cell. The UE 502 may be configured to communicate with the base station 504. For example, in the context of FIG. 1, the base station 504 may correspond to base station 102/180 and, accordingly, the cell may include a geographic coverage area 110 in which communication coverage is provided and/or small cell 102′ having a coverage area 110′. Further, a UE 502 may correspond to at least UE 104. In another example, in the context of FIG. 3, the base station 504 may correspond to base station 310 and the UE 502 may correspond to UE 350. Optional aspects are illustrated with a dashed line.

As illustrated at 506, the base station 504 may indicate, to the UE 502, that a first beam indication scheme is enabled. The beam indication scheme may be based on any of a joint DL/UL TCI state, a DL TCI state, and UL TCI state, spatial relation information; a default PUCCH/SRS/PUSCH beam indication, or default PDSCH beam(s) indication.

The enablement of the first beam indication scheme may indicate that a second beam indication scheme is not enabled, or is disabled. In some aspects, the second beam indication scheme may not be enabled, or may be disabled, based on a conflict between the first beam indication scheme and the second beam indication scheme. In some aspects, the base station or the UE may determine that the second beam indication scheme is not enabled based on a relation rule between the first beam indication scheme and the second beam indication scheme. The base station may indicate that the first beam indication scheme is enabled based on a configuration of one or more beam indication. In some aspects, the base station may indicate that the first beam indication scheme is enabled based on an activation of one or more beam indication. The first beam indication scheme may include one of a joint DL and UL TCI state indication scheme. Based on the enablement of the DL and UL TCI state indication scheme, the UE and/or the base station may determine that a downlink TCI state indication scheme, an uplink TCI state indication scheme, and/or a spatial relation information indication scheme is not enabled or is disabled. Similarly, if the joint DL and UL TCI state indication scheme, the DL TCI state scheme, the UL TCI state indication scheme, or the spatial relation scheme is enabled, the UE may determine that a default PUCCH beam indication scheme, a default SRS beam indication scheme, a default PUSCH beam indication scheme, or a default PUSCH beam indication scheme is not enabled. Thus, the second beam indication scheme may include one of a joint DL and UL TCI state indication scheme, a downlink TCI state indication scheme, an uplink TCI state indication scheme, a spatial relation information indication scheme, a default PUCCH beam indication scheme, a default SRS beam indication scheme, a default PUSCH beam indication scheme, or a default PDSCH beam indication scheme.

As illustrated at 508, the UE 502 may determine that a first beam indication scheme is enabled. In some aspects, the UE 502 may determine that the first beam indication scheme is enabled based on a configuration of one or more beam indication. In some aspects, the UE 502 determines that the first beam indication scheme is enabled based on an activation of one or more beam indication.

In some aspects, the base station 504 may transmit the indication indicating that the first beam indication scheme is enabled. The base station 504 may transmit the indication indicating that the first beam indication scheme is enabled to the UE 502. The UE 502 may receive the indication indicating that the first beam indication scheme is enabled from the base station 504. The UE may determine that the first beam indication scheme is enabled based on the indication.

As illustrated at 510, the UE 502 may determine that a second beam indication scheme is not enabled based on the first beam indication scheme being enabled. In some aspects, the UE 502 may determine that the second beam indication scheme is not enabled based on a conflict between the first beam indication scheme and the second beam indication scheme. In some aspects, the UE 502 may determine that the second beam indication scheme is not enabled based on a relation rule between the first beam indication scheme and the second beam indication scheme. The second beam indication scheme includes one of a joint DL and UL TCI state indication scheme, a downlink TCI state indication scheme, an uplink TCI state indication scheme, a spatial relation information indication scheme, a default PUCCH beam indication scheme, a default SRS beam indication scheme, a default PUSCH beam indication scheme, or a default PDSCH beam indication scheme.

As illustrated at 512, the UE 502 may apply the first beam indication scheme. The UE 502 may apply the first beam indication scheme to determine one or more of an UL beam or a DL beam for communication with the base station 504.

As illustrated at 514, the base station 504 may apply the first beam indication scheme. The base station 504 may apply the first beam indication scheme to activate one or more of an UL beam or a DL beam for communication with the UE 502.

As illustrated at 516, the UE 502 and base station 504 may communicate with each other based on the applied beam indication scheme. For example, the UE 502 and the base station 504 may communicate with each other based on the first beam indication scheme, wherein the UE 502 and the base station 504 activate one or more of the UL beam or the DL beam for communication based on first beam indication beam scheme.

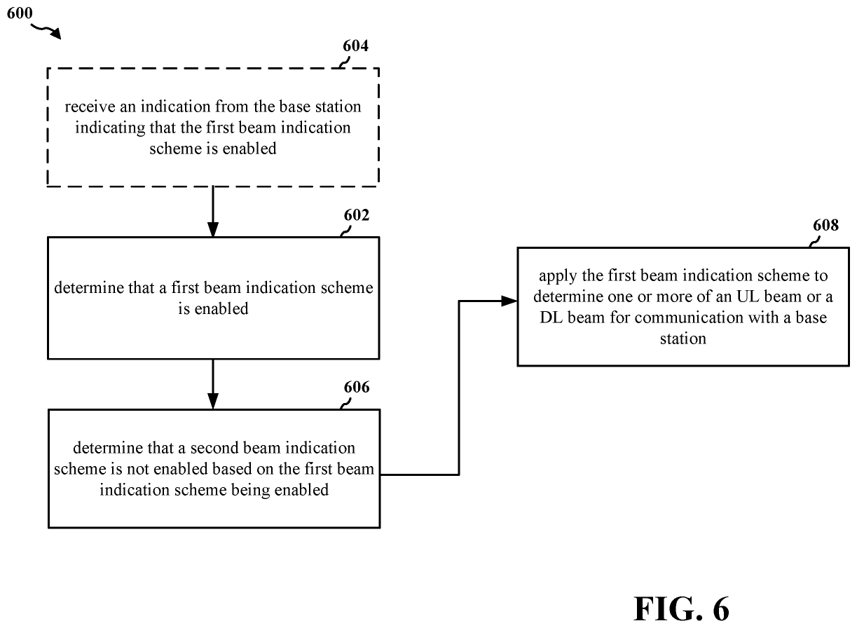

FIG. 6 is a flowchart 600 of a method of wireless communication. The method may be performed by a UE or a component of a UE (e.g., the UE 104, 502; the apparatus 702; the cellular baseband processor 704, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous. Optional aspects are illustrated with a dashed line. The method may specify, to a UE, an enablement relation rule for various beam indication schemes.

In some aspects, for example at 604, the UE may receive an indication indicating that the first beam indication scheme is enabled. For example, 604 may be performed by indication component 742 of apparatus 702. The UE may receive the indication indicating that the first beam indication scheme is enabled from a base station. The UE may determine that the first beam indication scheme is enabled based on the indication.

At 602, the UE may determine that a first beam indication scheme is enabled. For example, 602 may be performed by determination component 740 of apparatus 702. In some aspects, the UE may determine that the first beam indication scheme is enabled based on a configuration of one or more beam indication. In some aspects, the UE determines that the first beam indication scheme is enabled based on an activation of one or more beam indication. The first beam indication scheme may include one of a joint DL and UL transmission configuration indicator (TCI) state indication scheme, a downlink TCI state indication scheme, an uplink TCI state indication scheme, a spatial relation information indication scheme, a default physical uplink control channel (PUCCH) beam indication scheme, a default sounding reference signal (SRS) beam indication scheme, a default physical uplink shared channel (PUSCH) beam indication scheme, or a default physical downlink shared channel (PDSCH) beam indication scheme.

At 606, the UE may determine that a second beam indication scheme is not enabled based on the first beam indication scheme being enabled. For example, 606 may be performed by determination component 740 of apparatus 702. In some aspects, the UE may determine that the second beam indication scheme is not enabled based on a conflict between the first beam indication scheme and the second beam indication scheme. In some aspects, the UE may determine that the second beam indication scheme is not enabled based on a relation rule between the first beam indication scheme and the second beam indication scheme. The second beam indication scheme includes one of a joint DL and UL TCI state indication scheme, a downlink TCI state indication scheme, an uplink TCI state indication scheme, a spatial relation information indication scheme, a default PUCCH beam indication scheme, a default SRS beam indication scheme, a default PUSCH beam indication scheme, or a default PDSCH beam indication scheme.

At 608, the UE may apply the first beam indication scheme. For example, 608 may be performed by application component 744 of apparatus 702. The UE may apply the first beam indication scheme to determine one or more of an uplink (UL) beam or a downlink (DL) beam for communication with a base station.

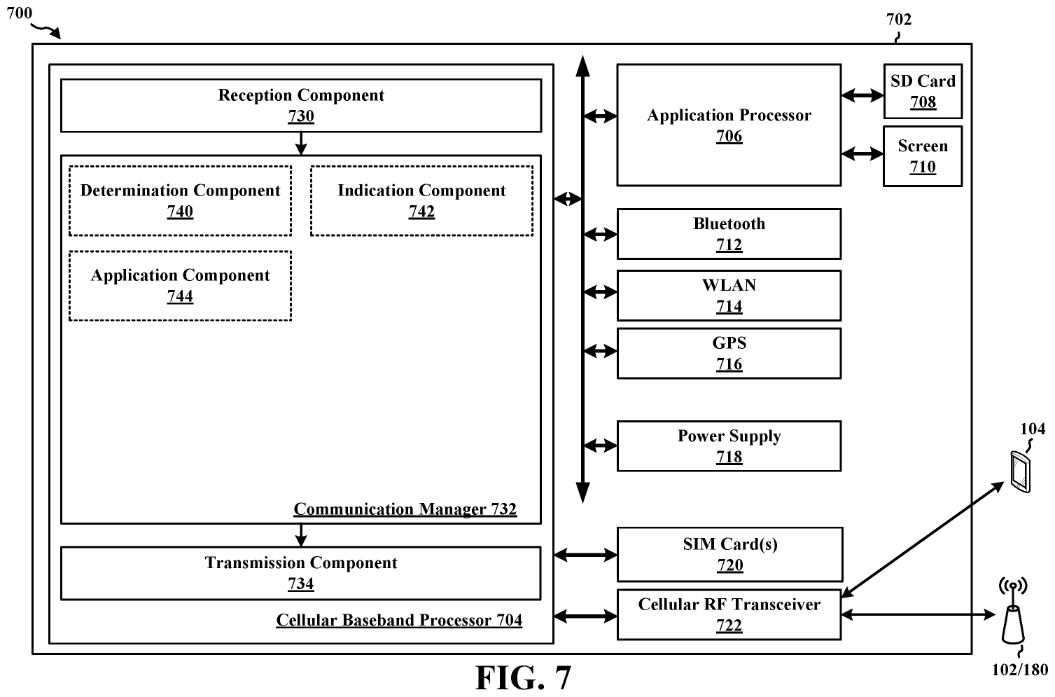

FIG. 7 is a diagram 700 illustrating an example of a hardware implementation for an apparatus 702. The apparatus 702 is a UE and includes a cellular baseband processor 704 (also referred to as a modem) coupled to a cellular RF transceiver 722 and one or more subscriber identity modules (SIM) cards 720, an application processor 706 coupled to a secure digital (SD) card 708 and a screen 710, a Bluetooth module 712, a wireless local area network (WLAN) module 714, a Global Positioning System (GPS) module 716, and a power supply 718. The cellular baseband processor 704 communicates through the cellular RF transceiver 722 with the UE 104 and/or BS 102/180. The cellular baseband processor 704 may include a computer-readable medium/memory. The computer-readable medium/memory may be non-transitory. The cellular baseband processor 704 is responsible for general processing, including the execution of software stored on the computer-readable medium/memory. The software, when executed by the cellular baseband processor 704, causes the cellular baseband processor 704 to perform the various functions described supra. The computer-readable medium/memory may also be used for storing data that is manipulated by the cellular baseband processor 704 when executing software. The cellular baseband processor 704 further includes a reception component 730, a communication manager 732, and a transmission component 734. The communication manager 732 includes the one or more illustrated components. The components within the communication manager 732 may be stored in the computer-readable medium/memory and/or configured as hardware within the cellular baseband processor 704. The cellular baseband processor 704 may be a component of the UE 350 and may include the memory 360 and/or at least one of the TX processor 368, the RX processor 356, and the controller/processor 359. In one configuration, the apparatus 702 may be a modem chip and include just the baseband processor 704, and in another configuration, the apparatus 702 may be the entire UE (e.g., see 350 of FIG. 3) and include the aforediscussed additional modules of the apparatus 702.

The communication manager 732 includes a determination component 740 that is configured to determine that a first beam indication scheme is enabled, e.g., as described in connection with 602 of FIG. 6. The determination component may be configured to determine that a second beam indication scheme is not enabled based on the first beam indication scheme being enabled, e.g., as described in connection with 606 of FIG. 6. The communication manager 732 further includes an indication component 742 that is configured to receive an indication indicating that the first beam indication scheme is enabled, e.g., as described in connection with 604 of FIG. 6. The communication manager 732 further includes an application component 744 that is configured to apply the first beam indication scheme, e.g., as described in connection with 608 of FIG. 6.

The apparatus may include additional components that perform each of the blocks of the algorithm in the aforementioned flowchart of FIG. 6. As such, each block in the aforementioned flowchart of FIG. 6 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 702, and in particular the cellular baseband processor 704, includes means for determining that a first beam indication scheme is enabled. The apparatus includes means for determining that a second beam indication scheme is not enabled based on the first beam indication scheme being enabled. The apparatus includes means for applying the first beam indication scheme to determine one or more of an UL beam or a DL beam for communication with a base station. The apparatus further includes means for receiving an indication from the base station indicating that the first beam indication scheme is enabled. The UE determines that the first beam indication scheme is enabled based on the indication. The aforementioned means may be one or more of the aforementioned components of the apparatus 702 configured to perform the functions recited by the aforementioned means. As described supra, the apparatus 702 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

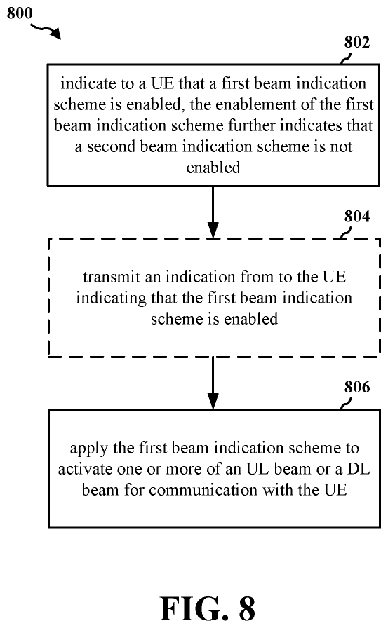

FIG. 8 is a flowchart 800 of a method of wireless communication. The method may be performed by a base station or a component of a base station (e.g., the base station 102/180, 504; the apparatus 902; the baseband unit 904, which may include the memory 376 and which may be the entire base station 310 or a component of the base station 310, such as the TX processor 316, the RX processor 370, and/or the controller/processor 375). One or more of the illustrated operations may be omitted, transposed, or contemporaneous. Optional aspects are illustrated with a dashed line. The method may allow a base station to specify, to a UE, an enablement relation rule for various beam indication schemes.

At 802, the base station may indicate that a first beam indication scheme is enabled. For example, 802 may be performed by indication component 940 of apparatus 902. The base station may indicate that the first beam indication scheme is enabled to a UE. Enablement of the first beam indication scheme further indicates that a second beam indication scheme is not enabled. In some aspects, the second beam indication scheme may not be enabled based on a conflict between the first beam indication scheme and the second beam indication scheme. In some aspects, the base station may determine that the second beam indication scheme is not enabled based on a relation rule between the first beam indication scheme and the second beam indication scheme. The base station may indicate that the first beam indication scheme is enabled based on a configuration of one or more beam indication. In some aspects, the base station may indicate that the first beam indication scheme is enabled based on an activation of one or more beam indication. The first beam indication scheme may include one of a joint DL and UL TCI state indication scheme, a downlink TCI state indication scheme, an uplink TCI state indication scheme, a spatial relation information indication scheme, a default PUCCH beam indication scheme, a default SRS beam indication scheme, a default PUSCH beam indication scheme, or a default PUSCH beam indication scheme. The second beam indication scheme may include one of a joint DL and UL TCI state indication scheme, a downlink TCI state indication scheme, an uplink TCI state indication scheme, a spatial relation information indication scheme, a default PUCCH beam indication scheme, a default SRS beam indication scheme, a default PUSCH beam indication scheme, or a default PDSCH beam indication scheme.

In some aspects, for example at 804, the base station may transmit an indication indicating that the first beam indication scheme is enabled. For example, 804 may be performed by indication component 940 of apparatus 902. The base station may transmit the indication indicating that the first beam indication scheme is enabled to a UE.

At 806, the base station may apply the first beam indication scheme. For example, 806 may be performed by application component 942 of apparatus 902. The base station may apply the first beam indication scheme to activate one or more of an UL beam or a DL beam for communication with the UE.

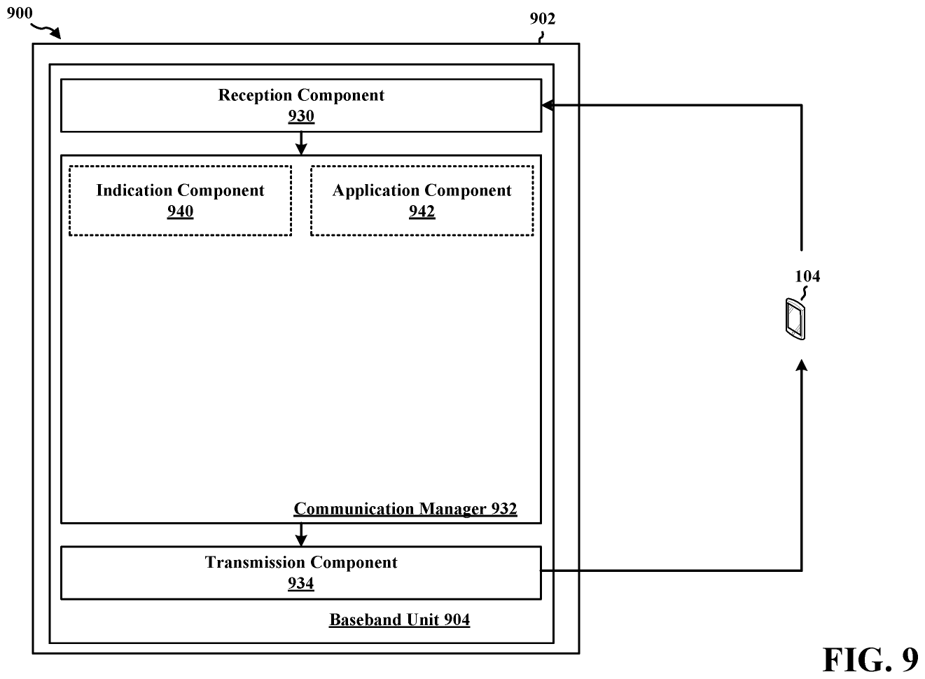

FIG. 9 is a diagram 900 illustrating an example of a hardware implementation for an apparatus 902. The apparatus 902 is a BS and includes a baseband unit 904. The baseband unit 904 may communicate through a cellular RF transceiver with the UE 104. The baseband unit 904 may include a computer-readable medium/memory. The baseband unit 904 is responsible for general processing, including the execution of software stored on the computer-readable medium/memory. The software, when executed by the baseband unit 904, causes the baseband unit 904 to perform the various functions described supra. The computer-readable medium/memory may also be used for storing data that is manipulated by the baseband unit 904 when executing software. The baseband unit 904 further includes a reception component 930, a communication manager 932, and a transmission component 934. The communication manager 932 includes the one or more illustrated components. The components within the communication manager 932 may be stored in the computer-readable medium/memory and/or configured as hardware within the baseband unit 904. The baseband unit 904 may be a component of the BS 310 and may include the memory 376 and/or at least one of the TX processor 316, the RX processor 370, and the controller/processor 375.

The communication manager 932 includes an indication component 940 that may indicate that a first beam indication scheme is enabled, e.g., as described in connection with 802 of FIG. 8. The indication component 940 may be configured to transmit an indication indicating that the first beam indication scheme is enabled, e.g., as described in connection with 804 of FIG. 8. The communication manager 932 further includes an application component 942 that may apply the first beam indication scheme, e.g., as described in connection with 806 of FIG. 8.

The apparatus may include additional components that perform each of the blocks of the algorithm in the aforementioned flowchart of FIG. 8. As such, each block in the aforementioned flowchart of FIG. 8 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 902, and in particular the baseband unit 904, includes means for indicating to a UE, that a first beam indication scheme is enabled. Enablement of the first beam indication scheme further indicates that a second beam indication scheme is not enabled. The apparatus includes means for applying the first beam indication scheme to activate one or more of an UL beam or a DL beam for communication with the UE. The apparatus further includes means for transmitting an indication to the UE indicating that the first beam indication scheme is enabled. The aforementioned means may be one or more of the aforementioned components of the apparatus 902 configured to perform the functions recited by the aforementioned means. As described supra, the apparatus 902 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The following examples are illustrative only and may be combined with aspects of other embodiments or teachings described herein, without limitation.

Example 1 is a method of wireless communication at a UE comprising determining that a first beam indication scheme is enabled; determining that a second beam indication scheme is not enabled based on the first beam indication scheme being enabled; and applying the first beam indication scheme to determine one or more of an uplink (UL) beam or a downlink (DL) beam for communication with a base station.

In Example 2, the method of Example 1 further includes that the UE determines that the second beam indication scheme is not enabled based on a conflict between the first beam indication scheme and the second beam indication scheme.

In Example 3, the method of Example 1 or 2 further includes that the UE determines that the second beam indication scheme is not enabled based on a relation rule between the first beam indication scheme and the second beam indication scheme.

In Example 4, the method of any of Examples 1-3 further includes receiving an indication from the base station indicating that the first beam indication scheme is enabled, wherein the UE determines that the first beam indication scheme is enabled based on the indication.

In Example 5, the method of any of Examples 1-4 further includes that the UE determines that the first beam indication scheme is enabled based on a configuration of one or more beam indication.

In Example 6, the method of any of Examples 1-5 further includes that the UE determines that the first beam indication scheme is enabled based on an activation of one or more beam indication.

In Example 7, the method of any of Examples 1-6 further includes that the first beam indication scheme includes one of a joint DL and UL TCI state indication scheme, a downlink TCI state indication scheme, an uplink TCI state indication scheme, a spatial relation information indication scheme, a default PUCCH beam indication scheme, a default SRS beam indication scheme, a default PUSCH beam indication scheme, or a default PDSCH beam indication scheme.

In Example 8, the method of any of Examples 1-7 further includes that the second beam indication scheme includes one of a joint DL and UL TCI state indication scheme, a downlink TCI state indication scheme, an uplink TCI state indication scheme, a spatial relation information indication scheme, a default PUCCH beam indication scheme, a default SRS beam indication scheme, a default PUSCH beam indication scheme, or a default PDSCH beam indication scheme.

Example 9 is a device including one or more processors and one or more memories in electronic communication with the one or more processors storing instructions executable by the one or more processors to cause the system or apparatus to implement a method as in any of Examples 1-8.

Example 10 is a system or apparatus including means for implementing a method or realizing an apparatus as in any of Examples 1-8.

Example 11 is a non-transitory computer readable medium storing instructions executable by one or more processors to cause the one or more processors to implement a method as in any of Examples 1-8.

Example 12 is a method of wireless communication of a base station comprising indicating to a user equipment (UE), that a first beam indication scheme is enabled, wherein enablement of the first beam indication scheme further indicates that a second beam indication scheme is not enabled; and applying the first beam indication scheme to activate one or more of an uplink (UL) beam or a downlink (DL) beam for communication with the UE.

In Example 13, the method of Example 12 further includes that the second beam indication scheme is not enabled based on a conflict between the first beam indication scheme and the second beam indication scheme.

In Example 14, the method of Example 12 or 13 further includes that the base station determines that the second beam indication scheme is not enabled based on a relation rule between the first beam indication scheme and the second beam indication scheme.

In Example 15, the method of any of Examples 12-14 further includes transmitting an indication to the UE indicating that the first beam indication scheme is enabled.

In Example 16, the method of any of Examples 12-15 further includes that the base station indicates that the first beam indication scheme is enabled based on a configuration of one or more beam indication.

In Example 17, the method of any of Examples 12-16 further includes that the base station indicates that the first beam indication scheme is enabled based on an activation of one or more beam indication.

In Example 18, the method of any of Examples 12-17 further includes that the first beam indication scheme includes one of a joint DL and UL TCI state indication scheme, a downlink TCI state indication scheme, an uplink TCI state indication scheme, a spatial relation information indication scheme, a default PUCCH beam indication scheme, a default SRS beam indication scheme, a default PUSCH beam indication scheme, or a default PDSCH beam indication scheme.

In Example 19, the method of any of Examples 12-18 further includes that the second beam indication scheme includes one of a joint DL and UL TCI state indication scheme, a downlink TCI state indication scheme, an uplink TCI state indication scheme, a spatial relation information indication scheme, a default PUCCH beam indication scheme, a default SRS beam indication scheme, a default PUSCH beam indication scheme, or a default PUSCH beam indication scheme.

Example 20 is a device including one or more processors and one or more memories in electronic communication with the one or more processors storing instructions executable by the one or more processors to cause the system or apparatus to implement a method as in any of Examples 12-19.

Example 21 is a system or apparatus including means for implementing a method or realizing an apparatus as in any of Examples 12-19.

Example 22 is a non-transitory computer readable medium storing instructions executable by one or more processors to cause the one or more processors to implement a method as in any of Examples 12-19.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method of wireless communication of a user equipment (UE), comprising:
determining that a first beam indication scheme is enabled;
determining that a second beam indication scheme is not enabled based on the first beam indication scheme being enabled; and
applying the first beam indication scheme to determine one or more of an uplink (UL) beam or a downlink (DL) beam for communication with a base station.

2. The method of claim 1, wherein the UE determines that the second beam indication scheme is not enabled based on a conflict between the first beam indication scheme and the second beam indication scheme.

3. The method of claim 1, wherein the UE determines that the second beam indication scheme is not enabled based on a relation rule between the first beam indication scheme and the second beam indication scheme.

4. The method of claim 1, further comprising:
receiving an indication from the base station indicating that the first beam indication scheme is enabled, wherein the UE determines that the first beam indication scheme is enabled based on the indication.

5. The method of claim 1, wherein the UE determines that the first beam indication scheme is enabled based on a configuration of one or more beam indication.

6. The method of claim 1, wherein the UE determines that the first beam indication scheme is enabled based on an activation of one or more beam indication.

7. The method of claim 1, wherein the first beam indication scheme includes one of:
a joint DL and UL transmission configuration indicator (TCI) state indication scheme,
a downlink TCI state indication scheme,
an uplink TCI state indication scheme,
a spatial relation information indication scheme,
a default physical uplink control channel (PUCCH) beam indication scheme,
a default sounding reference signal (SRS) beam indication scheme,
a default physical uplink shared channel (PUSCH) beam indication scheme, or
a default physical downlink shared channel (PDSCH) beam indication scheme.

8. The method of claim 1, wherein the second beam indication scheme includes one of:
a joint DL and UL transmission configuration indicator (TCI) state indication scheme,
a downlink TCI state indication scheme,
an uplink TCI state indication scheme,
a spatial relation information indication scheme,
a default physical uplink control channel (PUCCH) beam indication scheme,
a default sounding reference signal (SRS) beam indication scheme,
a default physical uplink shared channel (PUSCH) beam indication scheme, or
a default physical downlink shared channel (PDSCH) beam indication scheme.

9-12. (canceled)

13. A method of wireless communication of a base station, comprising:
indicating to a user equipment (UE), that a first beam indication scheme is enabled, wherein enablement of the first beam indication scheme further indicates that a second beam indication scheme is not enabled; and
applying the first beam indication scheme to activate one or more of an uplink (UL) beam or a downlink (DL) beam for communication with the UE.

14. The method of claim 13, wherein the second beam indication scheme is not enabled based on a conflict between the first beam indication scheme and the second beam indication scheme.

15. The method of claim 13, wherein the base station determines that the second beam indication scheme is not enabled based on a relation rule between the first beam indication scheme and the second beam indication scheme.

16. The method of claim 13, further comprising:
transmitting an indication to the UE indicating that the first beam indication scheme is enabled.

17. The method of claim 13, wherein the base station indicates that the first beam indication scheme is enabled based on a configuration of one or more beam indication.

18. The method of claim 13, wherein the base station indicates that the first beam indication scheme is enabled based on an activation of one or more beam indication.

19. The method of claim 13, wherein the first beam indication scheme includes one of:
a joint DL and UL transmission configuration indicator (TCI) state indication scheme,
a downlink TCI state indication scheme,
an uplink TCI state indication scheme,
a spatial relation information indication scheme,
a default physical uplink control channel (PUCCH) beam indication scheme,
a default sounding reference signal (SRS) beam indication scheme,
a default physical uplink shared channel (PUSCH) beam indication scheme, or
a default physical downlink shared channel (PDSCH) beam indication scheme.

20. The method of claim 13, wherein the second beam indication scheme includes one of:
a joint DL and UL transmission configuration indicator (TCI) state indication scheme,
a downlink TCI state indication scheme,
an uplink TCI state indication scheme,
a spatial relation information indication scheme,
a default physical uplink control channel (PUCCH) beam indication scheme,
a default sounding reference signal (SRS) beam indication scheme,
a default physical uplink shared channel (PUSCH) beam indication scheme, or
a default physical downlink shared channel (PDSCH) beam indication scheme.

21-24. (canceled)

25. An apparatus for wireless communication at a user equipment (UE), comprising:
a memory; and
at least one processor coupled to the memory and, based at least in part on information stored in the memory, the at least one processor is configured to:
determine that a first beam indication scheme is enabled;
determine that a second beam indication scheme is not enabled based on the first beam indication scheme being enabled; and
apply the first beam indication scheme to determine one or more of an uplink (UL) beam or a downlink (DL) beam for communication with a base station.

26. The apparatus of claim 25, further comprising a transceiver coupled to the at least one processor.

27. The apparatus of claim 25, wherein the at least one processor is configured to:
receive an indication from the base station indicating that the first beam indication scheme is enabled, wherein the UE determines that the first beam indication scheme is enabled based on the indication.

28. The apparatus of claim 25, wherein the UE determines that the first beam indication scheme is enabled based on a configuration of one or more beam indication.

29. The apparatus of claim 25, wherein the UE determines that the first beam indication scheme is enabled based on an activation of one or more beam indication.

30. The apparatus of claim 25, wherein the first beam indication scheme includes one of:
a joint DL and UL transmission configuration indicator (TCI) state indication scheme,
a downlink TCI state indication scheme,
an uplink TCI state indication scheme,
a spatial relation information indication scheme,
a default physical uplink control channel (PUCCH) beam indication scheme,
a default sounding reference signal (SRS) beam indication scheme,
a default physical uplink shared channel (PUSCH) beam indication scheme, or
a default physical downlink shared channel (PDSCH) beam indication scheme.

31. The apparatus of claim 25, wherein the second beam indication scheme includes one of:
a joint DL and UL transmission configuration indicator (TCI) state indication scheme,
a downlink TCI state indication scheme,
an uplink TCI state indication scheme,
a spatial relation information indication scheme,
a default physical uplink control channel (PUCCH) beam indication scheme,
a default sounding reference signal (SRS) beam indication scheme,
a default physical uplink shared channel (PUSCH) beam indication scheme, or
a default physical downlink shared channel (PDSCH) beam indication scheme.

32. An apparatus for wireless communication at a base station, comprising:
a memory; and
at least one processor coupled to the memory and, based at least in part on information stored in the memory, the at least one processor is configured to:
indicate to a user equipment (UE), that a first beam indication scheme is enabled, wherein enablement of the first beam indication scheme further indicates that a second beam indication scheme is not enabled; and
apply the first beam indication scheme to activate one or more of an uplink (UL) beam or a downlink (DL) beam for communication with the UE.

33. The apparatus of claim 32, further comprising a transceiver coupled to the at least one processor.

34. The apparatus of claim 32, wherein the at least one processor is configured to:
transmit an indication to the UE to indicate that the first beam indication scheme is enabled.

35. The apparatus of claim 32, wherein the base station indicates that the first beam indication scheme is enabled based on a configuration of one or more beam indication.

36. The apparatus of claim 32, wherein the base station indicates that the first beam indication scheme is enabled based on an activation of one or more beam indication.

37. The apparatus of claim 32, wherein the first beam indication scheme includes one of:
a joint DL and UL transmission configuration indicator (TCI) state indication scheme,
a downlink TCI state indication scheme,
an uplink TCI state indication scheme,
a spatial relation information indication scheme,
a default physical uplink control channel (PUCCH) beam indication scheme,
a default sounding reference signal (SRS) beam indication scheme,
a default physical uplink shared channel (PUSCH) beam indication scheme, or
a default physical downlink shared channel (PDSCH) beam indication scheme.

38. The apparatus of claim 32, wherein the second beam indication scheme includes one of:
a joint DL and UL transmission configuration indicator (TCI) state indication scheme,
a downlink TCI state indication scheme,
an uplink TCI state indication scheme,
a spatial relation information indication scheme,
a default physical uplink control channel (PUCCH) beam indication scheme,
a default sounding reference signal (SRS) beam indication scheme,
a default physical uplink shared channel (PUSCH) beam indication scheme, or
a default physical downlink shared channel (PDSCH) beam indication scheme.
